(19) United States
(12) Patent Application Publication
(10) Pub. No.: US 2007/0250661 A1
(43) Pub. Date: Oct. 25, 2007

(54) Data recording apparatus and method of controlling the same

(75) Inventors: Yoriharu Takai, Kodaira-shi (JP); Kenji Yoshida, Akishima-shi (JP); Koichi Nishide, Tachikawa-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/783,687

(22) Filed: Apr. 11, 2007

(30) Foreign Application Priority Data
Apr. 24, 2006 (JP) 2006-119614

(51) Int. Cl. G06F 13/00

(52) U.S. Cl. 711/113

(57) ABSTRACT

According to one embodiment, a data recording apparatus includes an input unit to which a commands is input, a disk-shaped recording medium, a nonvolatile memory which serves as a cache memory for the disk-shaped recording medium, and a control unit which records the data recorded in the nonvolatile memory onto the disk-shaped recording medium on the basis of a command to turn off a function of using the nonvolatile memory as a cache memory for the disk-shaped recording medium, which is input to the input unit.

### CROSS-REFERENCE TO RELATED APPLICATIONS

This application is based upon and claims the benefit of priority from Japanese Patent Application No. 2006-119614, filed Apr. 24, 2006, the entire contents of which are incorporated herein by reference.

### BACKGROUND

1. Field

One embodiment of the invention relates to a data recording apparatus which writes data by using a nonvolatile semiconductor memory as a cache, onto a high-capacity disk-shaped recording medium such as, for example, a hard disk or the like, and to a method of controlling the data recording apparatus.

2. Description of the Related Art

As is commonly known, in recent years, hard disks have become high-capacity and highly reliable data recording media, and have seen widespread use in many fields for recording of, for example, computer data, video data, audio data, and the like. Further, the shapes of hard disks have been miniaturized so as to be mountable in portable electronic devices.

Therefore, currently, in a miniaturized data recording apparatus using a hard disk, it is considered that, by using a nonvolatile memory which can achieve high-speed writing and high-speed reading of data as a cache memory for the hard disk, an attempt is made to save battery energy by improving writing and reading speeds of data, and by reducing the number of hard disk accesses, i.e., the number of writes and reads of data with respect to the hard disk.

Namely, this type of data recording apparatus makes a nonvolatile memory carry out writing and reading of data with respect to the outside, and makes a hard disk carry out data transfer with the nonvolatile memory, which speeds up operations for writing and reading data as viewed from the outside, and reduces the number of hard disk accesses. This type of data recording apparatus is called a nonvolatile (NV)-cache compliant hard disk drive (HDD), which has been standardized.

Here, in the data recording apparatus in which an attempt has been made to speed up operations for writing and reading data, and to reduce the number of hard disk accesses, it has been considered that a flash memory is used as a nonvolatile memory serving as a cache. A flash memory has a limitation to the number of rewrites (for example, about a hundred thousand times), and has the characteristic in which, when the number exceeds the limitation, errors are extremely easily produced, which lowers the reliability thereof.

Therefore, in a data recording apparatus in which recording of data is carried out onto a hard disk by using a nonvolatile memory as a cache, it has been strongly requested, not only to make an attempt to save electricity by reducing the number of hard disk accesses, but also to make improvement so as to efficiently control operations for writing and reading data in consideration of the fact that there is a limitation to the number of rewrites of the nonvolatile memory, and the ease of use for users.

In Jpn. Pat. Appln. KOKAI Publication No. 2004-55102, there is disclosed a high-capacity storage medium in which both a memory card and an HDD are mounted. The high-capacity storage medium can back up, for example, data of the memory card acquired from the outside, into the hard disk serving as a magnetic recording medium, and can transfer the data of the hard disk to the memory card to be loaded.

Further, in Japanese Patent No. 3407317, there is disclosed a portable storage device using a flash memory. In this Japanese Patent No. 3407317, in order to solve the problem that errors are easily produced when the number of rewrites (for example, a hundred thousand times) of a flash memory is increased, a method for managing data is provided in which, for example, the number of rewrites of only a specific area is prevented from increasing.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows one embodiment of the present invention, and is a block diagram shown for explanation of an outline of a data recording apparatus;

FIG. 2 is a diagram shown for explanation of recording areas of a flash memory used for the data recording apparatus in the embodiment;

FIG. 3 is a diagram shown for explanation of counters of a flash memory interface used for the data recording apparatus in the embodiment;

FIG. 4 is a block diagram shown for explanation of one example of a controller used for the data recording apparatus in the embodiment;

FIG. 5 is a block diagram shown for explanation of one example of a host device connected to the data recording apparatus in the embodiment;

FIG. 6 is a flowchart shown for explanation of one example of processing operations of the controller in the embodiment;

FIG. 7 is a flowchart shown for explanation of another example of processing operations of the controller in the embodiment; and

FIG. 8 is a flowchart shown for explanation of yet another example of processing operations of the controller in the embodiment.

### DETAILED DESCRIPTION

Various embodiments according to the invention will be described hereinafter with reference to the accompanying drawings. In general, according to one embodiment of the invention, a data recording apparatus includes an input unit to which a commands is input, a disk-shaped recording medium, a nonvolatile memory which serves as a cache memory for the disk-shaped recording medium, and a control unit which records the data recorded in the nonvolatile memory onto the disk-shaped recording medium on the basis of a command to turn off a function of using the nonvolatile memory as a cache memory for the disk-shaped recording medium, which is input to the input unit.

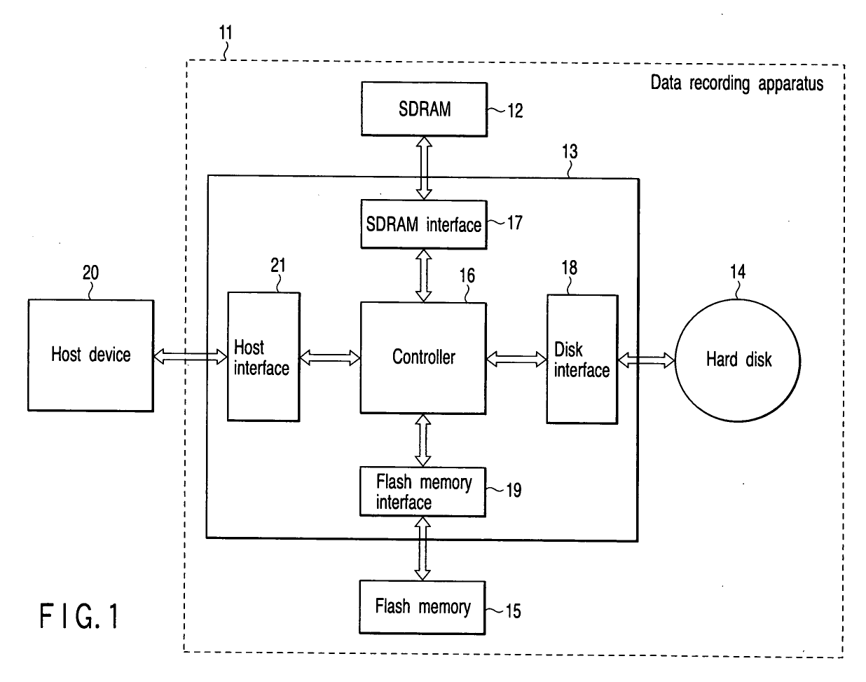

FIG. 1 shows an outline of a data recording apparatus 11 which will be described in the present embodiment. As the data recording apparatus 11 which will be described hereinafter, an NV-cache compliant HDD which is standardized in accordance with Non Volatile Cache Command Proposal for ATA8-ACS Revision 5 or the like, is regarded as a target.

Namely, the data recording apparatus 11 has an SDRAM 12 functioning as a buffer, a one-chip LSI 13 having various built-in circuit blocks, a hard disk 14 serving as a high-capacity disk-shaped recording medium, and a flash memory 15 serving as a nonvolatile memory functioning as a cache for the hard disk 14, or the like.

A controller 16 which will be a control unit for carrying out overall control of the apparatus when the data recording apparatus 11 executes various processing operations, is mounted in the LSI 13. Then, in the LSI 13, an SDRAM interface 17 which connects the controller 16 and the SDRAM 12 so as to transfer data therebetween, a disk interface 18 which connects the controller 16 and the hard disk 14 so as to transfer data therebetween, a flash memory interface 19 which connects the controller 16 and the flash memory 15 so as to transfer data therebetween, and a host interface 21 which connects the controller 16 and the external host device 20 so as to transfer data therebetween, or the like are built in.

Here, the above-described host device 20 is, for example, a personal computer (PC) or the like. For example, at the time of executing predetermined application software, the host device 20 executes writing and reading of data by utilizing the data recording apparatus 11, and can utilize the data recording apparatus 11 as a destination to save data obtained finally as well.

In this case, the host device 20 issues a command to request writing of data or a command to request reading of data with respect to the data recording apparatus 11. These commands are supplied to the controller 16 via the host interface 21 to be analyzed.

In accordance therewith, the controller 16 controls the SDRAM 12, the flash memory 15, the hard disk 14, or the like to selectively execute writing of data supplied from the host device 20, reading of data to the host device 20, or the like. Note that the controller 16 has a function capable of transferring data among the SDRAM 12, the flash memory 15, and the hard disk 14.

Basically, when a request to write data from the host device 20 is received, the controller 16 makes the flash memory 15 record data which is to be written. Then, the controller 16 transfers the data recorded in the flash memory 15 to the hard disk 14 to be stored in a predetermined timing, for example, when recording areas of the flash memory 15 are used to some extent or more.

Further, when a request to read data from the host device 20 is received, the controller 16 reads the required data from the hard disk 14 to be output to the host device 20. In this case, when there is the requested data on the flash memory 15, the data is read from the flash memory 15, and is output to the host device 20.

Here, an error correcting code is added to the data to be written to the flash memory 15. Then, error checking and correcting processing based on the error correcting code is applied to the data read from the flash memory 15.

Further, an error correcting code is added to the data to be recorded in the hard disk 14 as well. Then, error checking and correcting processing based on the error correcting code is applied to the data read from the hard disk 14.

In the present embodiment, a system is used in which the error correcting capability of error checking and correcting processing applied to the data to be recorded in the hard disk 14 is extremely higher than that of the error checking and correcting processing applied to the data to be recorded in the flash memory 15. Namely, the reliability of the data to be recorded in the hard disk 14 is dramatically higher than that of the data to be recorded in the flash memory 15.

Further, in the present embodiment, as one example, with respect to the flash memory 15, a unit of writing and reading data is regulated to 2 K bytes. Moreover, with respect to the flash memory 15, a unit of erasing is regulated to 128 K bytes. Further, with respect to the flash memory 15, as the number of writes and reads is increased, the element deteriorates, which increases the incidence of errors. Therefore, as data for assuring the performance of the element, the number of rewrites is regulated to about a hundred thousand times.

Here, among various commands which are set by the above-described regulations and can be executed by the data recording apparatus 11, commands necessary for explanation of the present embodiment will be described. First, a first command is to specify a logical block address (LBA) for writing data to the flash memory 15 among LBAs on the hard disk 14.

Further, a second command is, in the same way as the first command, to specify an LBA for writing data to the flash memory 15. However, in addition thereto, the second command is to request to read the data recorded in the LBA from the hard disk 14, and to write the read data to the flash memory 15.

The first and second commands described above correspond to PI=0 and PI=1 of Add LBA(s) to NV Cache Pinned Set in the regulations described above, and attribute data called pinned is added to an LBA instructed by the host device 20 to store the data in the flash memory 15.

A third command is to request to write data by specifying an LBA on the hard disk 14. When the third command is issued from the host device 20, the controller 16 examines whether or not pinned attribute data is made to correspond to the LBA requested to write. Then, when it is made to correspond thereto, writing is executed to an area corresponding to the LBA requested to write in the flash memory 15.

In contrast thereto, when the pinned attribute data is not made to correspond to the LBA requested to write, the controller 16 determines whether to write the data to an area corresponding to the specified LBA in the flash memory 15, or to write the data to the specified LBA of the hard disk 14 at its own judgment, and executes it.

A fourth command is to request to read data by specifying an LBA on the hard disk 14. When the fourth command is issued from the host device 20, an area corresponding to the specified LBA is already assigned on the flash memory 15, and it is judged that data newer than that on the hard disk 14 is stored in the area, the controller 16 needs to read the appropriate data from the flash memory 15.

In contrast thereto, when there is the same data on the hard disk 14 and the flash memory 15, the controller 16 may read the appropriate data from the area corresponding to the LBA requested to read in the flash memory 15, and may read the data from the specified LBA in the hard disk 14.

Further, in the case where, although the area corresponding to the specified LBA is already assigned on the flash memory 15, there is the latest data on the hard disk 14, the controller 16 needs to read the appropriate data from the specified LBA in the hard disk 14. Then, when the data is read from the hard disk 14, the controller 16 judges as well whether or not the data is cached in the flash memory 15.

Among LBAs to which pinned attribute data have not been made to correspond among the LBAs requested to write or read as the third and fourth commands described above, with respect to an LBA in which an area is assigned in the flash memory 15, and data is written to the assigned area in the flash memory 15, attribute data called unpinned is added.

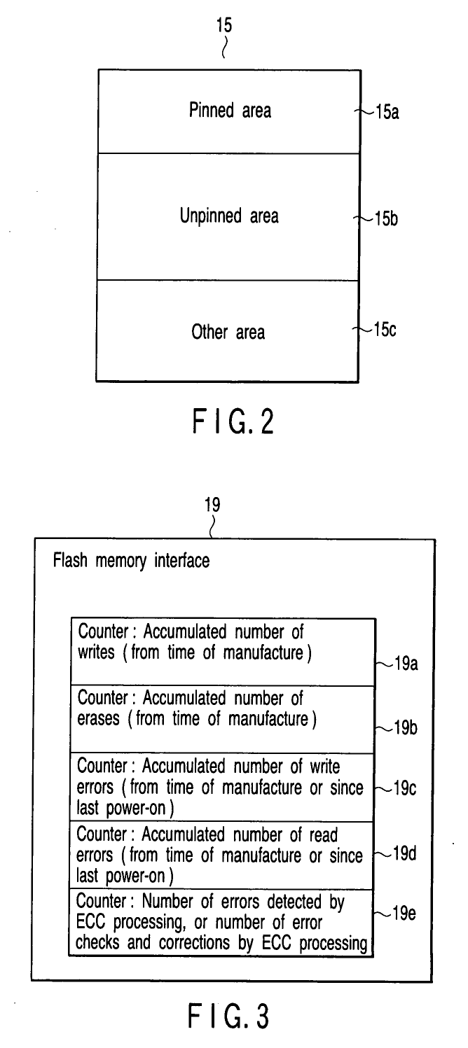

Then, an LBA to which pinned attribute data has been added is called a pinned LBA, and an area on the flash memory 15 corresponding to the pinned LBA is called a pinned area. Further, an LBA to which unpinned attribute data has been added is called an unpinned LBA, and an area on the flash memory 15 corresponding to the unpinned LBA is called an unpinned area. Therefore, on the flash memory 15, as shown in FIG. 2, a pinned area 15a, an unpinned area 15b, and other area 15c are formed.

A fifth command is to request to prepare a space area of only a specified size in the flash memory 15. When the fifth command is issued from the host device 20, and a current space area in the flash memory 15 is smaller than a requested space area, the controller 16 secures a space area of a specified size in the flash memory 15 by moving data of a specified size or more to the hard disk 14 from the unpinned area 15b in the flash memory 15. In this case, it is judged at the discretion of the controller 16 what data in which area in the unpinned area 15b in the flash memory 15 is moved to the hard disk 14, i.e., in which area in the flash memory 15 a space area is formed.

A sixth command is to execute a function of using the flash memory 15 as a cache for the hard disk 14, and called a “Set NV Cache Power Mode”. When the sixth command is issued from the host device 20, the controller 16 can execute an access to the flash memory 15.

Namely, the controller 16 is made capable of carrying out writing and reading of data with respect to the flash memory 15 when the first to fifth commands are supplied in a state in which the sixth command has been supplied. In other words, the host device 20 needs to issue the first to fifth commands after issuing the sixth command.

A seventh command is to turn off the function of using the flash memory 15 as a cache for the hard disk 14, and is called a “Return From NV Cache Power Mode”. When the seventh command is issued from the host device 20, the controller 16 cannot execute an access to the flash memory 15.

Namely, after the seventh command has been supplied, the controller 16 is made incapable of carrying out the first, second, and fifth commands. Further, the controller 16 operates to execute only writing and reading of data with respect to the hard disk 14 in response to the third and fourth commands.

Next, the above-described flash memory interface 19 will be described. The flash memory interface 19 has a function of connecting the controller 16 and the flash memory 15 so as to transfer data therebetween, and in addition, as shown in FIG. 3, various counters 19a to 19e are provided thereto. Respective counted values of these counters 19a to 19e are stored in, for example, an unillustrated nonvolatile memory provided in the flash memory interface 19. Note that it is possible to utilize the flash memory 15 in order to store the counted values.

First, the counter 19a is to accumulatively count the number of writes from the time of manufacture. The counter 19b is to accumulatively count the number of erases from the time of manufacture. The counter 19c accumulatively counts the number of write errors from the time of manufacture (or since the last power-on). The counter 19d accumulatively counts the number of read errors from the time manufacture (or since the last power-on). The counter 19e accumulatively counts the number of errors detected by error checking and correcting (ECC) processing, or the number of error corrections by ECC processing. A degraded status of the flash memory 15 can be judged on the basis of the counted values of these respective counters 19a to 19e.

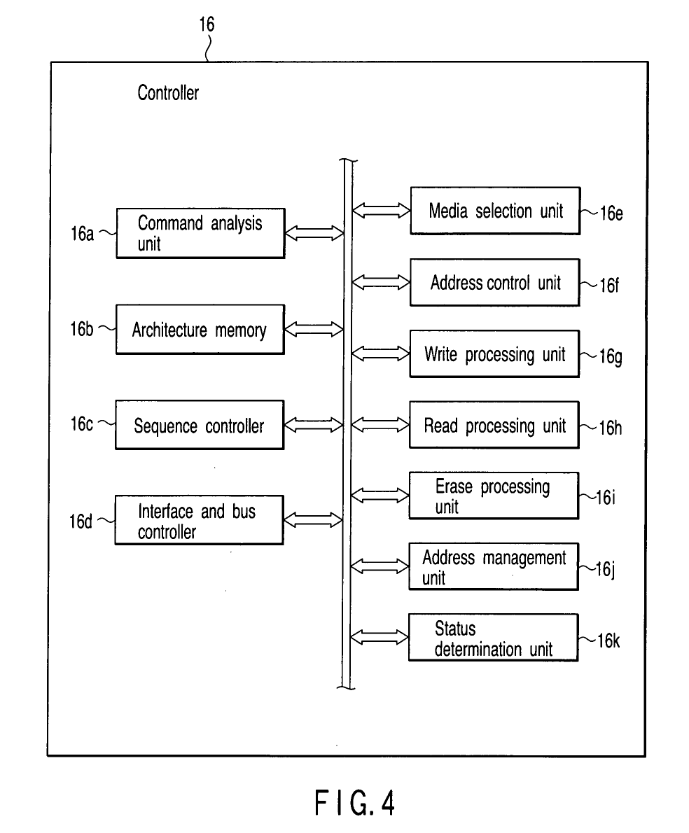

FIG. 4 shows one example of the above-described controller 16. The controller 16 has a command analysis unit 16a which analyzes a command supplied from the host device 20 by applying decode processing thereto. As a result of the analysis by the command analysis unit 16a, software in an architecture memory 16b is specified, which sets an operational procedure into a sequence controller 16c.

The sequence controller 16c controls a flow of data via an interface and bus controller 16d. For example, when writing or reading of data is carried out, a media selection unit 16e specifies the flash memory 15 or the hard disk 14, and an address control unit 16f specifies a write address or a read address.

Then, during the writing of data, a write processing unit 16g executes transfer processing of data to be written. Further, during the reading of data, a read processing unit 16h executes transfer processing of data to be read.

Moreover, an erase processing unit 16i is provided to the controller 16. The erase processing unit 16i executes erase processing of data recorded in the flash memory 15. Further, the erase processing unit 16i can execute erase processing of data recorded in the hard disk 14 as well.

Further, an address management unit 16j is provided to the controller 16. The address management unit 16j collectively manages addresses of recorded areas, unrecorded areas, and the like on the flash memory 15 and the hard disk 14. Moreover, a status judgment unit 16k for monitoring a driving status of the hard disk 14 is provided to the controller 16.

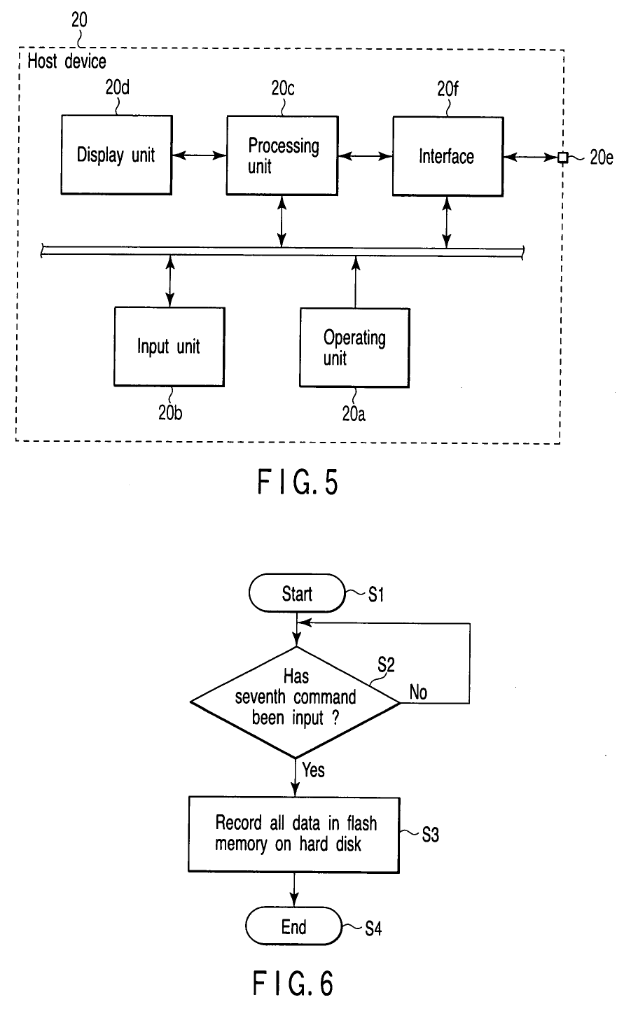

FIG. 5 shows one example of the above-described host device 20. The host device 20 has an operating unit 20a operated by a user, and an input unit 20b for carrying out acquisition of data from an external network or a predetermined data recording medium on the basis of an operation of the operating unit 20a.

Further, the host device 20 applies predetermined signal processing to data acquired by the input unit 20b, and has a processing unit 20c which generates a command for the data recording apparatus 11, and a display unit 20d for displaying a processing result of the processing unit 20c.

Moreover, the host device 20 has an interface 20f for outputting data serving as a processing result from the processing unit 20c or a command to the outside (the data recording apparatus 11) via a joining terminal 20e, and for supplying data input via the joining terminal 20e from the outside (the data recording apparatus 11), to the processing unit 20c.

Here, as described above, the flash memory 15 is used as a cache for the hard disk 14, and in a state in which the sixth command has been issued, when a request to write data from the host device 20 is received, the flash memory 15 functions such that the data to be written is once recorded, and is transferred to be stored in the hard disk 14 at a predetermined timing.

Therefore, data which is the same as the data recorded in the hard disk 14, or data requested to be written from the host device 20 after data has been recorded in the hard disk 14 for the last time is recorded in the flash memory 15.

Namely, when update date-and-hour of the data recorded in the flash memory 15, and update date-and-hour of the data recorded in the hard disk 14 are compared, there is a possibility that data having the same update date-and-hour as that of the data recorded in the hard disk 14, or data having update date-and-hour which is newer than that of the data recorded in the hard disk 14 is recorded in the flash memory 15.

On the other hand, as described above, the error correcting capability of the error checking and correcting processing applied to data to be recorded in the hard disk 14 is extremely higher than that of the error checking and correcting processing applied to data to be recorded in the flash memory 15, and thus the reliability of the data to be recorded in the hard disk 14 is dramatically higher than that of the data to be recorded in the flash memory 15.

Further, the flash memory 15 is easy to be broken as compared with the hard disk 14, and the reliability of the data to be recorded therein is dramatically lower than that of the hard disk 14. Namely, data can be stored in the hard disk 14 in a more reliable state than that in the flash memory 15.

By the way, when the seventh command to turn off the function of using the flash memory 15 as a cache for the hard disk 14 is issued, the controller 16 cannot access the flash memory 15. Therefore, even if data which has not been written to the hard disk 14 is included in the data recorded in the flash memory 15 before the seventh command is issued, it is impossible to write the data to the hard disk 14 to be stored in a highly reliable state.

In the standard described above, when the seventh command is issued, handling of data recorded in the flash memory 15 (without regard to the pinned area 15a or the unpinned area 15b) is undefined. Therefore, when the data recorded in the flash memory 15 is lost before being stored in the hard disk 14, the data recording apparatus 11 cannot output correct data in response to a read command from the host device 20.

Then, in the embodiment, when the seventh command to turn off the function of using the flash memory 15 as a cache for the hard disk 14 is issued, data recorded in the flash memory 15, without regard to the pinned area 15a or the unpinned area 15b, is automatically transferred to the hard disk 14.

FIG. 6 shows one example of processing operations in which the controller 16 automatically transfers data recorded in the flash memory 15 to the hard disk 14 when the seventh command has been issued. Namely, when the processing is started (block S1), at block S2, the controller 16 judges whether or not the seventh command has been input. Then, when it is judged that the seventh command has been input (YES), at block S3, the controller 16 transfers all the data recorded in the flash memory 15 to be recorded in the hard disk 14, and the process is completed (block S4).

In accordance with the operational example shown in FIG. 6, all the data recorded in the flash memory 15 is automatically recorded in the hard disk 14 when the seventh command is input. Thus, even if the data recorded in the flash memory 15 is lost, it is possible to greatly raise the possibility that correct data has been recorded in the hard disk 14.

In this manner, in response to a read command from the host device 20, it is possible to read correct data from the hard disk 14 to output, and high-speed and highly reliable writing and reading operations can be achieved, and handling for a user can be made convenient.

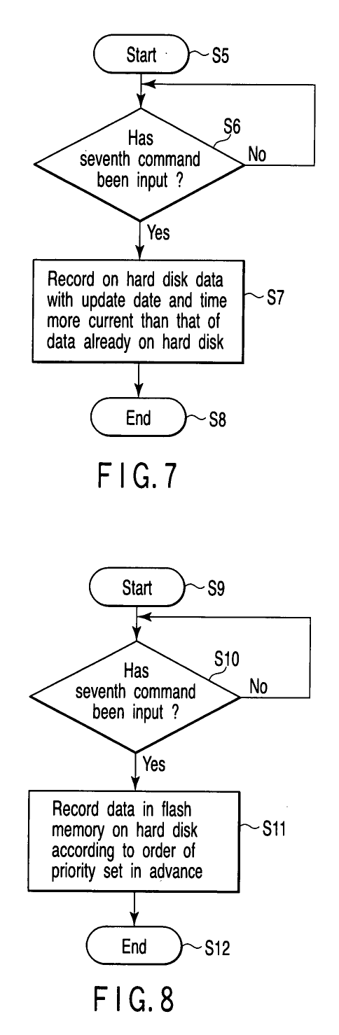

FIG. 7 shows another example of processing operations in which the controller 16 automatically transfers data recorded in the flash memory 15 to the hard disk 14 when the seventh command is issued. Namely, when the processing is started (block S5), at block S6, the controller 16 judges whether or not the seventh command has been input.

Then, when it is judged that the seventh command has been input (YES), at block S7, the controller 16 transfers only data with update date-and-hour newer than the update date-and-hour of the data recorded in the hard disk 14 among the data recorded in the flash memory 15, to the hard disk 14 to be recorded, and the process is completed (block S8).

In accordance with the operational example shown in FIG. 7, when the seventh command is input, only data with update date-and-hour newer than the update date-and-hour of the data recorded in the hard disk 14 among the data recorded in the flash memory 15, is transferred to the hard disk 14 to be recorded. Therefore, a transfer time can be made shorter than the case in which all the data recorded in the flash memory 15 is recorded in the hard disk 14.

FIG. 8 shows yet another example of processing operations in which the controller 16 automatically transfers data recorded in the flash memory 15 to the hard disk 14 when the seventh command is issued. Namely, when the processing is started (block S9), at block S10, the controller 16 judges whether or not the seventh command has been input.

Then, when it is judged that the seventh command has been input (YES), at block S11, the controller 16 transfers the data recorded in the flash memory 15 to the hard disk 14 to be recorded according to an order of priority set in advance, and the process is completed (block S12).

With respect to the order of priority set in advance at the block S11, for example, data written to the flash memory 15 on the basis of a command, such as the first command, to request writing to the flash memory 15 is given top priority, and next, data written to the flash memory 15 by judgment of the controller 16, such as the third command, is given priority.

In accordance with the operational example shown in FIG. 8, when the seventh command is issued, the data recorded in the flash memory 15 is transferred to the hard disk 14 to be recorded according to an order of priority set in advance. Therefore, when there is a limitation to a time from when the seventh command is issued up to the time the controller 16 executes processing based on a next command, it is possible to record data in order of necessity into the hard disk 14 within the time limit.

Further, the above-described processing operations shown in FIGS. 6 to 8 can be appropriately combined with each other. For example, it is possible to control such that, when there is a predetermined or more time from when the seventh command is issued up to the time the controller 16 executes the processing based on the next command, the processing operations shown in FIG. 6 are selected, and when it is impossible to insure a predetermined or more time, the processing operations shown in FIG. 7 are selected.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data recording apparatus comprising:
an input unit configured to receive an input of command;
a disk-shaped recording medium;
a nonvolatile memory configured to serve as a cache memory for the disk-shaped recording medium; and
a control unit configured to carry out writing of data to the nonvolatile memory on the basis of a write command input to the input unit, recording of data recorded in the nonvolatile memory onto the disk-shaped recording medium in a predetermined timing, and recording of the data recorded in the nonvolatile memory onto the disk-shaped recording medium on the basis of a command to turn off a function of using the nonvolatile memory as a cache memory for the disk-shaped recording medium, which is input to the input unit.

2. A data recording apparatus according to claim 1, wherein
the control unit controls all the data recorded in the nonvolatile memory so as to be recorded onto the disk-shaped recording medium on the basis of the command to turn off the function of using the nonvolatile memory as a cache memory for the disk-shaped recording medium, which is input to the input unit.

3. A data recording apparatus according to claim 1, wherein
the control unit controls data with update date-and-hour newer than update date-and-hour of the data recorded in the disk-shaped recording medium among the data recorded in the nonvolatile memory so as to be recorded onto the disk-shaped recording medium on the basis of the command to turn off the function of using the nonvolatile memory as a cache memory for the disk-shaped recording medium, which is input to the input unit.

4. A data recording apparatus according to claim 1, wherein
the control unit controls the data recorded in the nonvolatile memory so as to be recorded onto the disk-shaped recording medium according to an order of priority set in advance on the basis of the command to turn off the function of using the nonvolatile memory as a cache memory for the disk-shaped recording medium, which is input to the input unit.

5. A data recording apparatus according to claim 4, wherein,
with respect to the order of priority set in advance, data written to the nonvolatile memory on the basis of a write command to request recording data into the nonvolatile memory, which is input to the input unit, is given top priority.

6. A data recording apparatus according to claim 1, wherein
the control unit selects control to record all the data recorded in the nonvolatile memory onto the disk-shaped recording medium in accordance with a time from when the command to turn off the function of using the nonvolatile memory as a cache memory for the disk-shaped recording medium is input up to a time processing based on a following command is executed, and control to record data with update date-and-hour newer than update date-and-hour of the data recorded in the disk-shaped recording medium among the data recorded in the nonvolatile memory, onto the disk-shaped recording medium.

7. A data recording apparatus according to claim 1, wherein
the disk-shaped recording medium is a hard disk, and the nonvolatile memory is a flash memory.

8. A method for controlling a data recording apparatus, comprising:
a first block of inputting a command;
a second block of writing data to a nonvolatile memory serving as a cache memory for a disk-shaped recording medium, on the basis of a write command input at the first block;
a third block of recording the data recorded in the nonvolatile memory at the second block onto the disk-shaped recording medium in a predetermined timing; and
a fourth block of recording the data recorded in the nonvolatile memory onto the disk-shaped recording medium on the basis of a command to turn off a function of using the nonvolatile memory as a cache memory for the disk-shaped recording medium, which is input at the first block.

9. A method for controlling a data recording apparatus according to claim 8, wherein
the fourth block controls all the data recorded in the nonvolatile memory so as to be recorded onto the disk-shaped recording medium on the basis of the command to turn off the function of using the nonvolatile memory as a cache memory for the disk-shaped recording medium, which is input at the first block.

10. A method for controlling a data recording apparatus according to claim 8, wherein
the fourth block controls data with update date-and-hour newer than update date-and-hour of the data recorded in the disk-shaped recording medium among the data recorded in the nonvolatile memory so as to be recorded onto the disk-shaped recording medium on the basis of the command to turn off the function of using the nonvolatile memory as a cache memory for the disk-shaped recording medium, which is input at the first block.

11. A method for controlling a data recording apparatus according to claim 8, wherein
the fourth block controls the data recorded in the nonvolatile memory so as to be recorded onto the disk-shaped recording medium according to an order of priority set in advance on the basis of the command to turn off the function of using the nonvolatile memory as a cache memory for the disk-shaped recording medium, which is input at the first block.

12. A method for controlling a data recording apparatus according to claim 11, wherein,
with respect to the order of priority set in advance, data written to the nonvolatile memory on the basis of a write command to request recording data into the nonvolatile memory, which is input at the first block, is given top priority.

13. A method for controlling a data recording apparatus according to claim 8, wherein
the fourth block selects control to record all the data recorded in the nonvolatile memory onto the disk-shaped recording medium in accordance with a time from when the command to turn off the function of using the nonvolatile memory as a cache memory for the disk-shaped recording medium is input up to a time processing based on a following command is executed, and control to record data with update date-and-hour newer than update date-and-hour of the data recorded in the disk-shaped recording medium among the data recorded in the nonvolatile memory, onto the disk-shaped recording medium.
